(19) United States
(12) Patent Application Publication
(10) Pub. No.: US 2022/0130566 A1
(43) Pub. Date: Apr. 28, 2022

(54) METHOD FOR THE DESTRUCTION OF ORGANIC MATERIAL

(71) Applicant: C-TECH INNOVATION LIMITED, Chester (GB)

(72) Inventors: Robert BELL, Chester (GB); John COLLINS, Chester (GB); Peter EDDOWES, Wirral (GB)

(21) Appl. No.: 17/428,819

(22) PCT Filed: Feb. 6, 2020
(86) PCT No.: PCT/GB2020/050266

§ 371 Date: Aug. 5, 2021

(30) Foreign Application Priority Data
Feb. 6, 2019 (GB) 1901659.1

(51) Int. Cl. G21F 9/06; C25B 15/08; G21F 9/30

(52) U.S. Cl. CPC G21F 9/06; G21F 9/30; C25B 15/081

(57) ABSTRACT

A method and apparatus for the electrochemically mediated oxidation of radioactive organic materials comprising the step of mixing aqueous phase that contains the oxidising agent with immiscible non-aqueous phase containing organic material that is to be destroyed in a chamber fitted with a contactor to integrate the aqueous phase with the organic material.

### BACKGROUND OF THE INVENTION

### 1. Field of the Invention

This invention relates to the destruction of organic waste materials, particularly those generated in the nuclear industry.

### 2. The Prior Art

The nuclear industry experiences significant problems regarding the safe disposal of organic materials that are contaminated with radioactive species. Radioactive contaminated organic liquid wastes can include hydraulic oils, liquid extractant systems such as TBP/OK, coolants, lubricants, solvents and analytical reagents. These can be in the form of aqueous soluble organics, immiscible organics and emulsions. Solid organic contaminated waste includes ion-exchange resins, gloves, seals, wipes, and other miscellaneous waste and debris from coatings and surfaces. Such materials are often to be found stored in small quantities in multiple distributed locations such as laboratories and stores on different sites.

Processing methods in use for radioactive wastes are suitable for inorganic wastes and not for organic wastes. An example is the enhanced actinide recovery process (EARP) operated at the UK Sellafield site [OSPAR Commission, 2005: “The Application of BAT in UK Nuclear Facilities Report” UK Report on Implementation of PARCOM Recommendation 91/4 on radioactive discharges”] EP 0297738 A (STEELE DF) 4 Jan. 1989 which will handle nitric acid based aqueous solutions containing radioactive nuclides. This process was not designed to treat organic solids or liquids and will not tolerate them because they interfere with the flocculation of metal hydroxides which then gives increased risk of radioactive discharge to the environment via the supernatant.

In consequence, there exist contaminated organic materials in storage on nuclear sites for which there exists no practical of effective means of processing. The requirement is to stabilise these materials in order to prevent unintended leaching prior to long-term storage, destruction to carbon dioxide, or surface decontamination to reduce the concentration of radioactive species and allow waste declassification.

A range of destruction methods for liquid and solid organics exist for use in non-radioactively contaminated applications. These include pyrolysis, incineration, chemical oxidation and electrochemical oxidation either directly at the surface of electrodes or indirectly via a mediator species in solution. The required result of such a process is that the radioactive contamination is retained in a smaller volume of material for subsequent stabilisation and long-term storage whilst the organic material is substantially destroyed.

The use of an electrochemically mediated oxidation is known for the treatment by oxidation of organic wastes. In this approach the anode in an electrochemical cell is used to increase the oxidation state of mediator ions in solution which are then dispersed into the bulk electrolyte. The electrolyte is contacted with the organic material to be destroyed which is oxidised by the mediator. Very highly oxidising species can be created and regenerated on demand by anodic oxidation and these are comparable in effect to the most powerful conventional chemical oxidising agents such as permanganates and persulfates. The use of silver with oxidation states of +1 and +2 is known in this context—EP 0297738 A (STEELE DF) 4 Jan. 1989 (above). The application of oxidising solutions including silver in nitric acid is described for the purpose of the destruction of organic materials. In such systems the oxidising species is created in an electrochemical cell typically comprising two half-cells separated by an ion-exchange membrane or other porous separator. The anolyte solution contains the low oxidation state mediator species such as silver (I) in an acidic medium such as nitric acid which is oxidised up to silver (II) on the anode which is typically platinum. The catholyte is usually formed of a similar aqueous solution such as nitric acid but without the oxidation mediator. As the anolyte passes through the cell the oxidation state of the mediator is increased in an electrochemical reaction at the anode; in the case of silver from Ag (I) to Ag (II). In this example, the balancing reaction in the catholyte half-cell is the reduction of nitric acid. Other anolyte and catholyte and oxidation mediators and electrochemical reactions are possible include mixed mediator systems. The oxidation medium such as acidic silver (II) nitrate solution then passes to a vessel where it comes into contact with the contaminated organic material of concern with the purpose of oxidising the organic material and converting it into a form that can be discharged safely. Full conversion to carbon dioxide is a principle objective but partial oxidation may be acceptable. Oxidation of organic species is unlikely to be direct to carbon monoxide or carbon dioxide and many intermediate species will be formed. The electrochemically generated oxidising mediators are not stable and decay back to the lower oxidation state either by direct reaction with the organic molecules or by reaction with water which may also form radical species which oxidise organic molecules. The oxidation mediator is reduced to its lower oxidation state, silver (I) in the example described and then passes back to the electrochemical cell where it is once again oxidised up to Ag(II). The oxidation mediator is used in a closed loop. Cerium, cobalt and other elements are also known as redox agents in such systems—COURMOYER, et al. Parametric optimisation of the MEO process for treatment of mixed waste residues. WM99 Conference Proceedings. Feb. 28-Mar. 4, 1999 and U.S. Pat. No. 5,707,508 (SURMA ET AL) 13 Jan. 1998.

Mediation using electrochemical oxidation techniques above, theoretically, gives a number of advantages over thermal and chemical techniques. It can be operated at atmospheric pressure, it is non-pyrolytic and can be operated at low temperatures, it can destroy a wide range of liquid and solid organics, it is chemically safe with only a limited amount of oxidising species being present at any time, it is readily controllable with instantaneous cessation of oxidising agent production when the current is switched off, and it is scalable from small glove box systems up to full scale plants capable of destroying many kilograms of material per day.

However, a limitation with the oxidative destruction process as applied to organic liquids is that the rate of reaction between the redox mediator species such as silver (II) and the organic liquid material is limited by the immiscibility of the two liquids. The oxidising mediator is at a relatively low concentration in solution and chemically unstable and it needs to contact and react with the organic phase quickly and then be available for re-oxidation at the anode. A slow rate of reaction means that longer periods of operator oversight are required, and the equipment is relatively large for the volume of material being treated. This can render the approach ineffective for the purpose described.

A method of increasing the rate of reaction between two immiscible phases is to increase the area of the interface. For mechanical agitation, the degree of shear applied controls the particle size and typically a more highly sheared system will yield a smaller particle size and a correspondingly increased rate a reaction. Too fine a dispersion of insoluble phase may not be suitable however if it results in organic phase being drawn into the electrochemical cell and fouling the separator. An additional consideration when designing such an oxidative process is that the oxidation of the target organic material leads to the generation of carbon dioxide and other gases. These are generated at the interface between the fluids and can hinder the process if not continuously removed.

Ultrasound has been used to enhance mediated electrochemical oxidation of organic molecules both by formation of an emulsion prior to the electrochemical cell (U.S. Pat. No. 5,707,508 (STEEL DF) (above) and PCT/WO 03062495 A (LEGG S A ET AL) 31 Jul. 2003). The use of ultrasound can also be beneficial for treatment of solids especially those with organic contamination where it can assist in breaking up agglomerations and removal of surface films to increase contact area.

Known embodiments of the electrochemically mediated destruction of organic liquids involve the addition of the organic liquid to a stirred tank reactor. The concentration of organic phase is kept sufficiently low so that bulk organic liquid does not separate and thereby risk damaging the electrochemical cell separator. This approach has the undesirable consequence that the reactor vessel becomes proportionately large.

In summary there is no known means of using electrochemically mediated oxidative destruction of organic material that gives a sufficiently high rate of reaction, a long-lived electrochemical cell performance, and a sufficiently compact apparatus to result in equipment that is practically useful for the destruction of radioactively contaminated organic wastes of the sort stored on nuclear operating sites.

### SUMMARY OF THE INVENTION

According to a first aspect of the invention an electrochemically mediated method for the oxidation of organic material comprises the step of mixing aqueous phase that contains an electrochemically generated oxidising agent with immiscible non-aqueous phase containing organic material that is to be destroyed in a chamber fitted with a contactor to integrate the aqueous phase with the organic material.

In a method in which the organic material is in the form of a liquid the contactor may be mixing devices such as mechanical stirrers, rotating shear mixers, shedder plates, static in pipe mixers, turbulent pipe flow eductors, jet impingement devices. The location of point at which the organic material is introduced into the aqueous phase is important and is advantageously located immediately downstream of the electrochemical cell.

Effective contactor arrangements in the case of solid organic matter include fluidised beds with or without inert particulates, spray nozzles, filter beds.

For systems for both solid and liquid organic materials mixing may be augmented by the application of gas sparges or ultrasound or sonic waves. Ultrasound and sonic waves can be applied in the mixing vessel and or in a flow pipe immediately downstream of the electrochemical cell, where the injection point for the liquid organic phase may also be located. Any of the contactor arrangements described may be augmented by mechanical mixing devices.

It has been found surprisingly that a method according to the invention works effectively when the degree of dispersion of the organic material into the aqueous phase is arranged to be intermediate between a coarse and a fine emulsion. The rate of oxidative destruction of the organic phase is maximised when the surface area of the interface between aqueous and non-aqueous phases is matched to both the concentration of the oxidising agent and to the rate of breakdown of the organic material. Achieving this condition results in a system that can function at high efficiency and for prolonged periods without degradation of performance.

In a second aspect of the invention, apparatus for electro-chemically mediated oxidation of organic materials incudes an electrochemical cell generating or regenerating electro-chemical aqueous oxidation material and a mixing chamber in which the aqueous oxidation material is mixed using a contactor with organic material to be mediated. Preferably contact between the aqueous oxidation material and the organic material is immediately after introduction of the aqueous oxidation material into the mixing chamber.

In development of the second aspect of the invention apparatus for used for electro-chemical mediation of organic materials includes phase-disengagement device which promotes the separation of aqueous phase from organic material or the purposes of allowing regeneration of the mediator species whilst preventing damagingly high concentrations of the organic phase fouling the electrochemical cell includes a filter screen, mesh, foam or plate-coalescer device, hydro-cyclone or separator tank.

The electrochemical cell may include an ion exchange membrane of the type commonly used in electrochemical cells. The anolyte is the aqueous solution of oxidising species, for example a solution of silver nitrate in nitric acid. The catholyte may be nitric acid. A means of replacing or oxidising the catholyte is provided.

This invention forms a practical and robust arrangement for the destruction of organic matter. The system allows for a good rate of reaction at the same time as providing a reliable operation without risk of fouling of the cell membrane and without the need for moving parts in the contactor or coalescer. The arrangement is suitable for use in compact spaces such as glove boxes and compact skid-mounted equipment for mobile use. It is robust to presence of particulate contamination and is robust to the addition of aliquots of the contaminated phase.

The contactor and phase-disengagement aspects may be combined in a mixer-settler type arrangement. Unlike a conventional mixer-settler which has two liquid phases entering and two liquid phases leaving the device described here would have two liquid phases entering and only one liquid phase leaving. Unlike a conventional mixer in the system described in the present invention only the aqueous phase is circulated outside the mixer settler system. The organic phase is recirculated and destroyed within the device. The rate of addition of organic material is balanced by the rate of oxidation and evolution of gas.

### BRIEF DESCRIPTION OF DRAWINGS

The figures show two illustrative examples of apparatus employing the invention. However, the invention is not in any way limited to the configurations illustrated. In the figures:

FIG. 1 is a schematic drawing of one embodiment of the invention having a vertically orientated mixer-settler chamber; and

FIG. 2 is a schematic drawing of a second embodiment of the system with a horizontally orientated mixer-settler chamber.

### DETAILED DESCRIPTION OF THE PREFERRED EMBODIMENTS

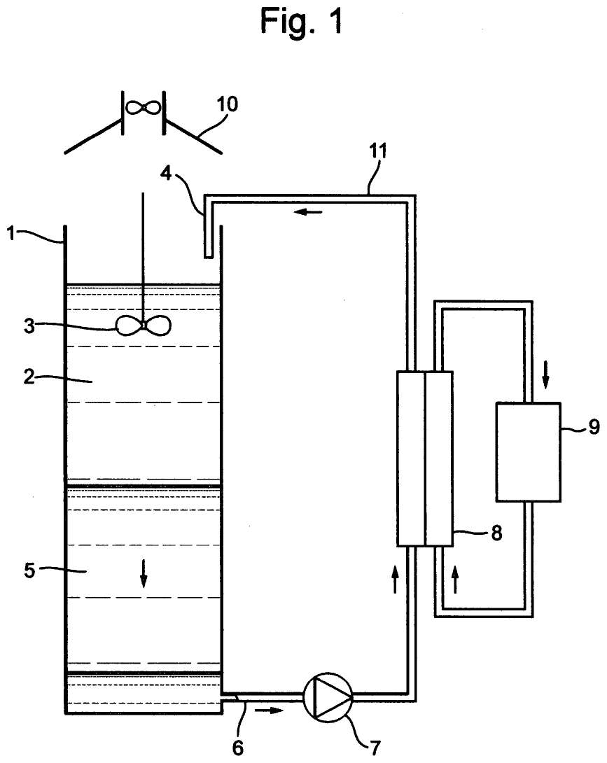

In FIG. 1, vessel 1 which is the body of the vertically orientated mixer-settler chamber. A mixing chamber 2 is provided with a stirrer or other contactor device 3. Contaminated non-aqueous organic material is added by injection into pipe 11 or directly into the mixing chamber 2. An aqueous phase containing the oxidising species, nitric acid, is continuously added to the mixing chamber 2 through pipe 4. The mixed solution passes downwards through a coalescer unit 5. Non-aqueous phase is captured in the coalesce unit and floats upwards whilst the aqueous phase moves downwards and exits the vessel through pipe 6. Pump 7 draws the aqueous phase out and pumps it through a divided electrochemical cell 8 where the oxidation mediator is oxidised and then back into the mixing chamber 2 via pipe 11. The balancing catholyte solution passes through the other side of divided cell 8 and through a regeneration device 9 which replenishes the higher oxidation state catholyte. A gas extraction system 10 is provided to remove the off gases and allow the destruction rate to be monitored by measuring the amount of carbon dioxide produced.

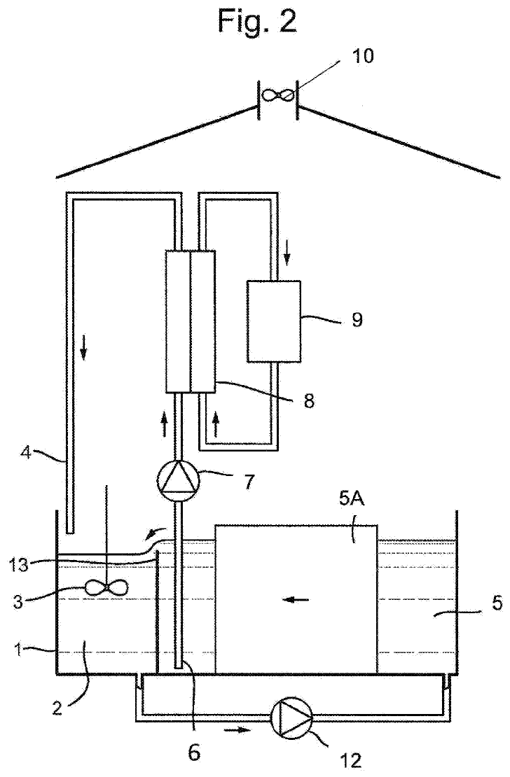

A second embodiment of the system is shown in FIG. 2. A vessel 1 is the body of a horizontally orientated mixer-settler chamber. A mixing chamber 2 is agitated with a stirrer 3. Contaminated non-aqueous phase is added directly to the mixing chamber 2. An aqueous phase containing the oxidising species (nitric acid) is continuously added to the mixing chamber 2 through pipe 4. A mixture of both phases is drawn from the mixing chamber by pump 12 and pumped into a separate coalescer unit 5 which has a coalescer device 5A. The coalesce device 5A comprises a filter screen, mesh, foam or plate-coalescer device, hydro-cyclone or separator tank.

The heavy aqueous phase settles to the bottom of the settling chamber 5 and drawn out of the settling chamber through pipe 6 and pumped by pump 7 through one side of a divided electrochemical cell 8 and thence back into the mixing chamber through pipe 4. The separated light phase containing residual organic material flows over a weir 13 back into the mixing chamber 2. The balancing catholyte solution passes through the other side of divided cell 8 and through a regeneration device 9 which replenishes the higher oxidation state catholyte. A gas extraction system 10 is provided to the off gases and allow the destruction rate to be monitored by measuring the amount of carbon dioxide produced.

Other embodiments of the components of the system will be apparent to those skilled in the art.

### EXAMPLES OF USE OF THE INVENTION

The following are examples of the destruction of organic materials using apparatus of the present invention.

### Example 1 the Destruction of Contaminated Hydraulic Oil

Hydraulic oil was treated using a solution of silver nitrate in nitric acid in experiments to show the benefit of this invention. The oil was substantially oxidised to carbon dioxide using a solution of 0.2 mol % silver nitrate in 6 M nitric acid was used as the anolyte. The test was conducted with a 1 litre of electrolyte in both the anolyte and catholyte circuits of an electrochemical divided electrochemical cell the catholyte used contained 6 M nitric acid with no silver nitrate addition. The cell had a 25 square centimetre area electrode area and the separation membrane used is an ion exchange membrane. The cell was operated with a DC current and similar flow rates in both electrolyte streams, the current density used was 4000 A per square metre. Both electrolytes were heated to 333 K and known aliquots of oil were added to the anolyte solution. The anolyte was circulated through a reaction vessel where the return to the cell was at the base of the vessel. The analysis of the carbon dioxide quantities produced was converted into a current efficiency by matching the moles of Ag(II) generated with the carbon dioxide production.

Two experiments were conducted. In the first experiment a standard overhead lab stirrer was positioned at the interface between the oil and aqueous immiscible phases and the cell operated with the electrolyte feed entering the vessel into the aqueous phase below the oil phase. In this experiment run over 3 hours the cell voltage stabilised at 4 V and the overall current efficiency was 12% with the remaining species decaying in the aqueous phase. In the second experiment several changes were made to the experiment coalescence media was included at the base of the reaction vessel to remove oil prior to return to the electrochemical cell, the oil addition was made into the flow of anolyte exiting the electrochemical cell and subsequently passed through an inline static mixer before entering the reaction vessel and, the flow from the cell entered the reaction vessel above the liquid level and was distributed across the oil layer by means of a shedder plate set to generate the appropriate level of dispersion of the fluid. In this experiment operating over 3 hours the current efficiency was over 85% the voltage in the cell dropped to 2.6 V while maintaining the same current density. These results show the improvement achieved by controlling the mixing of the immiscible fluids and the reduction in voltage is due to reduction in organic species entering the electrochemical cell.

### Example 2 the Destruction of Contaminated Ion Exchange Resin Beads

Ion exchange resin was treated using a solution of silver nitrate in nitric acid. The ion exchange resin was arranged as a fluidised bed, fluidised by the incoming stream of aqueous phase. Radioactive contamination was simulated using a trace non-radioactive metallic element present in a suitable form. The resin beads were substantially oxidised to carbon dioxide. The trace element was substantially transferred into the aqueous solution in a form suitable for subsequent treatment and recovery by means of conventional nuclear processing such as precipitation or solvent extraction.

### Example 3 the Destruction of Contaminated Synthetic Glove Material

Shredded glove material was treated using a solution of silver nitrate in nitric acid. Radioactive contamination was simulated using a trace non-radioactive metallic element present in a suitable form. It was found that a relatively short treatment time gave a sufficient degree of decontamination for the reclassification of the waste material to a grade more easily disposed of. Longer treatment resulted in the glove material being substantially oxidised to carbon dioxide. The trace element was substantially transferred into the aqueous solution in a form suitable for subsequent treatment and recovery by means of conventional nuclear processing such as precipitation or solvent extraction.

### Example 4 the Destruction of Contaminated Organic Matter Immobilised onto Inert Particles

For some contaminated material it may be advantageous to immobilise it onto solid particles of high surface area which are present in the contactor as a packed bed or fluidised bed. In this example an organic oil of high viscosity was distributed over the surface of silica beads. The beads were packed into a column through which the oxidising aqueous phase flowed. A non-radioactive metallic element present in a suitable chemical form was substantially transferred to the aqueous phase.

In the above examples a metallic non-radioactive marker was used as a substitute for a radioactive species. In live systems according to the invention, the radioactive species are indeed transferred into the aqueous (nitric acid) phase. They will remain in the aqueous phase and accumulate there until the aqueous phase is sent for conventional nuclear treatment.

1. An electrochemically mediated method for the oxidation of organic material comprising the step of mixing aqueous phase that contains an electrochemically generated oxidising agent with immiscible non-aqueous phase containing organic material that is to be destroyed in a chamber fitted with a contactor to integrate the aqueous phase with the organic material.

2. The electrochemically mediated method for the oxidation of organic material according to claim wherein the non-aqueous phase is in the form of a liquid and the contactor comprises one or more mixing devices.

3. The electrochemically mediated method for the oxidation of organic material according to claim 1, wherein the non-aqueous phase is in the form of a liquid, the contactor comprises one or more mixing devices, and the one or more mixing devices comprise one or more mechanical stirrers, rotating shear mixers, shedder plates, static in pipe mixers, turbulent pipe flow eductors, and jet impingement devices.

4. The electrochemically mediated method for the oxidation of organic material according to claim 1, in which the non-aqueous phase is in the form of a liquid, the contactor comprises one or more mixing devices, and the non-aqueous phase containing the organic material is introduced into the aqueous phase immediately downstream of an electrochemical cell.

5. The electrochemically mediated method for the oxidation of organic material according to claim wherein the non-aqueous phase is in the form of a solid and in which the contactor comprises one or more of a fluidized bed, a fluidized bed with inert particulates, a fluidized bed with a spray nozzle, and a fluidized bed with a filter bed.

6. The electrochemically mediated method for the oxidation of organic material according to claim 1, in which the mixing is augmented by the application of gas sparges or ultrasound or sonic waves.

7. The electrochemically mediated method for the oxidation of organic material according to claim 1, in which ultrasound and sonic waves are applied to a mixing vessel and or in a flow pipe immediately downstream of an electrochemical cell.

8. The electrochemically mediated method for the oxidation of organic material according to claim 1, in which the organic material is dispersed into the aqueous phase to form a dispersion, and the degree of dispersion of the organic material into the aqueous phase is arranged to be intermediate between a coarse and a fine emulsion.

9. The electrochemically mediated method for the oxidation of organic material according to claim 1, in which a surface area of an interface between aqueous and non-aqueous phases is matched to both a concentration of the oxidising agent and to a rate of breakdown of the organic material.

10. The electrochemically mediated method for the oxidation of organic material according to claim 1, in which the electrochemically generated oxidising agent is generated in an electrochemical cell containing an electrolyte which includes one or more of the following elements, Ag, Cl, Br, Ce, and Co.

11. The electrochemically mediated method for the oxidation of organic material according to claim 1, in which a rate of addition of organic material is controlled by measuring a rate of evolution of gas.

12. The electrochemically mediated method for the oxidation of organic materials according to claim 1, further including an electrochemical cell generating or regenerating electrochemical aqueous oxidation material and a mixing chamber housing the contactor in which the aqueous oxidation material is mixed using the contactor with organic material to be mediated.

13. The electrochemically mediated method for the oxidation of organic materials according to claim 12, in which contact between the aqueous oxidation material and the organic material is immediately after introduction of the aqueous oxidation material into the mixing chamber.

14. The electrochemically mediated method for the oxidation of organic materials according to claim 12, further including a coalescer to promote at least partial separation of aqueous phase material from non-aqueous phase material.

15. The electrochemically mediated method for the oxidation of organic materials according to claim 12, further including a coalescer to promote at least partial separation of aqueous phase material from non-aqueous phase material, wherein the coalescer comprises a filter screen, mesh, foam coalescer, plate-coalescer, hydro-cyclone or separator tank.

16. The electrochemical mediation method for the oxidation of organic materials according to claim 12, in which the electrochemical cell comprises an ion exchange membrane in which an anolyte is the aqueous solution of an oxidising species and a catholyte is nitric acid.

17. The electrochemically mediated method for the oxidation of organic materials according to claim 12, further including a coalescer to promote at least partial separation of aqueous phase material from non-aqueous phase material, and wherein the contactor is combined in a single chamber with the coalescer.

18. The electrochemically mediated method for the oxidation of organic materials according to claim 12, further including a coalescer to promote at least partial separation of aqueous phase material from non-aqueous phase material, and wherein the contactor is combined in a single chamber with the coalescer, and the organic material is recirculated and destroyed within the single chamber.

19. The electrochemically mediated method for the oxidation of organic materials according to claim 12, in which of a rate of addition of organic material is controlled by measuring a rate of evolution of gas.

20. The electrochemically mediated method for the oxidation of organic materials according to claim 1, further including an electrochemical cell for generating or regenerating electrochemical aqueous oxidation material and a mixing chamber housing the contactor.
